(19) United States
(12) Patent Application Publication
(10) Pub. No.: US 2003/0211849 A1
(43) Pub. Date: Nov. 13, 2003

(54) Handover of a call connection in a cellular telecommunications network

(76) Inventor: Paul Robinson, Wiltshire (GB)

Correspondence Address: Docket Administrator (Room 3J-219), Lucent Technologies Inc., 101 Crawfords Corner Road, Holmdel, NJ, 07733-3030, US

(21) Appl. No.: 10/430,090

(22) Filed: May 6, 2003

(30) Foreign Application Priority Data
May 8, 2002 (GB) 0210541.9

(51) Int. Cl. H04Q 7/20

(52) U.S. Cl. 455/442; 455/453; 455/438

(57) ABSTRACT

A method is provided of handover of a call connection with a mobile user terminal from a first base station to a second base station in a cellular telecommunications network. Each base station having an associated cell. The method involves maintaining the call connection with the first base station even though the mobile user terminal is outside the cell associated with that first base station, until handover of the call connection to the second base station.

### CROSS REFERENCE TO RELATED APPLICATION

This application claims priority of Great Britain Application No. 0210541.9 filed on May 8, 2002.

### TECHNICAL FIELD

The present invention relates to a method of handover of a call connection with a mobile user terminal from a first base station to a second base station in a cellular telecommunications network. The present invention also relates to a cellular telecommunications network comprising a first base station and a second base station. The present invention also relates to a telecommunications base station having an associated cell.

### BACKGROUND OF THE INVENTION

When, for example, a Universal Mobile Telecommunications System UMTS frequency division duplex FDD network is deployed, services other than standard voice services will be more common. Such services include very high quality voice, multimedia, location services and other applications. Multimedia services, for example, require video connections and web-streaming which require high quality of guaranteed service data rates. Thus each service has an associated Quality of Service QoS requirement so is given a QoS service class ensuring performance at expected levels.

Known approaches support handovers but with no provision to maintain QoS service level when cells are congested. When only the QoS service level of a lower QoS service class is available, then inferior service is provided. Clearly in many circumstances the lower, default quality will be all that is available causing a degradation in the overall service level offered. In extreme cases a complete loss of the service results as even the minimum resources to continue the call cannot be provided.

As shown in FIGS. 1 and 2, a mobile radio telecommunications network 2′ consists of a network of base transceiver stations 4′ each having an associated cell (area of coverage) 6′. A mobile user terminal (user equipment UE) 8′ within the network 2′ is served by a serving cell 10′ in the sense of being in call connection 11′ with the base transceiver station 4 in the serving cell 10′. A significant problem is that, as shown in FIG. 2, a mobile user terminal UE 8′ moving through a serving cell 10′ is sometimes blocked from handing over to a neighbour cell 12′ at the desired service level or at all. The mobile user terminal UE 8′ seeks to handover to a neighbour cell 12′ at the desired service level but is blocked as all candidate neighbour cells 12′ are fully loaded (i.e. at their maximum planned capacity). In consequence, only a few options are available.

If a mobile user terminal UE 8′ needs to handover to an adjacent cells in its neighbour list (a neighbour cell 12′), but cannot as the neighbour cells 12′ are fully loaded for the planned QoS service level, the choice is basically to either drop to lower service level, or drop the call.

One option is to drop the call connection and re-establish the call connection when that becomes possible in new cell. Another option is to renegotiate down to a lower service level for the type call (voice, web-streaming, etc) being undertaken. A third option is to store i.e. buffer data until a next opportunity for a call connection of that service.

### SUMMARY OF THE INVENTION

The present invention provides a method of handover of a call connection with a mobile user terminal from a first base station to a second base station in a cellular telecommunications network, each base station having an associated cell, the method comprising maintaining the call connection with the first base station whilst the mobile user terminal is outside the cell associated with the first base-station until handover of the call connection to the second base station.

In preferred embodiments it will be seen that advantageously the serving cell is extended beyond normal coverage boundary and into neighbour regions. This technique which is to extend the coverage of the serving cell beyond the normal planning boundaries can be considered a form of conduit to the mobile user terminal UE. Preferred embodiments advantageously provide the user with the desired service level for a short period of time until a suitable handover candidate is acquired to maintain the desired service level. A required QoS level to a mobile user terminal (UE) is maintained even though the user terminal has moved out of the current serving cell but the network is unable to provide a handover to another, e.g. a nearer base station. The user is thus provided with a more reliable service. Any desired set of services having different QoS requirements are supported, with fewer interruptions or intermittent provision of those services.

Preferably the first base station has an associated quality of service level, that quality of service level being maintained after handover to the second base station.

Preferably the first base station is informed that it is permitted to continue to communicate with the mobile user terminal outside of the usual boundary of the cell of the first base station. Preferably the permission is conditional on signals from the mobile user terminal being sufficiently strong as to permit acceptably accurate-reception.

Preferably the first base station comprises a Rake receiver having multiple fingers, additional fingers being used whilst the mobile user terminal is outside the cell associated with the first base station and in call connection with the first base station so as to improve accuracy of reception.

Preferably the transmission power of the mobile user terminal is increased whilst the mobile user terminal is outside the cell associated with the first base station and in call connection with the first base station so as to improve accuracy of reception.

Preferably the call connection is maintained with the first base station whilst the mobile user terminal is outside the cell associated with the first base station whilst neighbour cells to the cell of the first base station are congested.

Preferably traffic is transferred to further cells so as to free up resources in the neighbour cells sufficiently that the base station in at least one of the neighbour cells can accept the handover. Preferably neighbour cells are identified in a neighbour list stored at the first base station and updated periodically.

Preferably the telecommunications network is a third generation or higher telecommunications network. Preferably the telecommunications network is a Universal Mobile Telecommunications System UMTS network.

The present invention also provides a cellular telecommunications network comprising a first base station and a second base station, each base station having an associated cell, the first base station being operative to be in a call connection with a mobile user terminal in which the call connection with the first base station is maintained whilst the mobile user terminal is outside the cell associated with the first base station until handover of the call connection to the second base station.

Preferably the call connection to the first base station has an associated quality of service level, that quality of service level being maintained after handover to the second base station.

Preferably the first base station is informed that it is permitted to continue to communicate with the mobile user terminal outside of the usual boundary of the cell of the first base station. Preferably the permission is conditional on signals from the mobile user terminal being sufficiently strong as to permit acceptably accurate reception.

Preferably the first base station comprises a Rake receiver having multiple fingers, additional fingers being used whilst the mobile user terminal is outside the cell associated with the first base station and in call connection with the first base station so as to improve accuracy of reception.

Preferably the transmission power of the mobile user terminal is increased whilst the mobile user terminal is outside the cell associated with the first base station and in call connection with the first base station so as to improve accuracy of reception.

Preferably the call connection is maintained with the first base station whilst the mobile user terminal is outside the cell associated with the first base station whilst neighbour cells to the cell of the first base station are congested. Preferably traffic is transferred to further cells so as to free up resources in the neighbour cells sufficiently that the base station in at least one of the neighbour cells can accept the handover. Preferably neighbour cells are identified in a neighbour list stored at the first base station and updated periodically.

Preferably the network is a third generation or higher telecommunications network. Preferably the network is a Universal Mobile Telecommunications System UMTS network.

The present invention also provides a telecommunications base station having an associated cell, the base station being operative to be in a call connection with a mobile user terminal, the call connection being maintained whilst the mobile user terminal is outside the cell until handover of the call connection to a further base station.

Preferably the call connection to the base station has an associated quality of service level, that quality of service level being maintained after handover.

Preferably the base station is informed that it is permitted to continue to communicate with the mobile user terminal outside of the usual boundary of the cell. Preferably the permission is conditional on signals from the mobile user terminal being sufficiently strong as to permit acceptably accurate reception.

Preferably the base station comprises a Rake receiver having multiple fingers, additional fingers being used whilst the mobile user terminal is outside the cell associated with the base station and in call connection with the base station so as to improve accuracy of reception.

Preferably the call connection is maintained with the base station whilst the mobile user terminal is outside the cell associated with the base station whilst neighbour cells to the cell of the base station are congested. Preferably neighbour cells are identified in a neighbour list stored at the base station and updated periodically.

Preferably the base station is a third generation or higher telecommunications base station. Preferably the base station is a Universal Mobile Telecommunications System UMTS base station, under the control of a radio network controller.

### BRIEF DESCRIPTION OF THE DRAWINGS

A preferred embodiment of the present invention will now be described by way of example and with reference to the drawings, in which:

FIG. 1 is a diagram illustrating a known telecommunications network (prior art) including a mobile user terminal,

FIG. 2 is a diagram illustrating the known telecommunications network and mobile user terminal as shown in FIG. 1 but with the mobile user terminal moved to the serving cell boundary (prior art),

FIG. 3 is a diagram illustrating a telecommunications network including a mobile user terminal just before handover according to the present invention, and

FIG. 4 is a diagram illustrating the telecommunications network including the mobile user terminal upon handover according to the present invention.

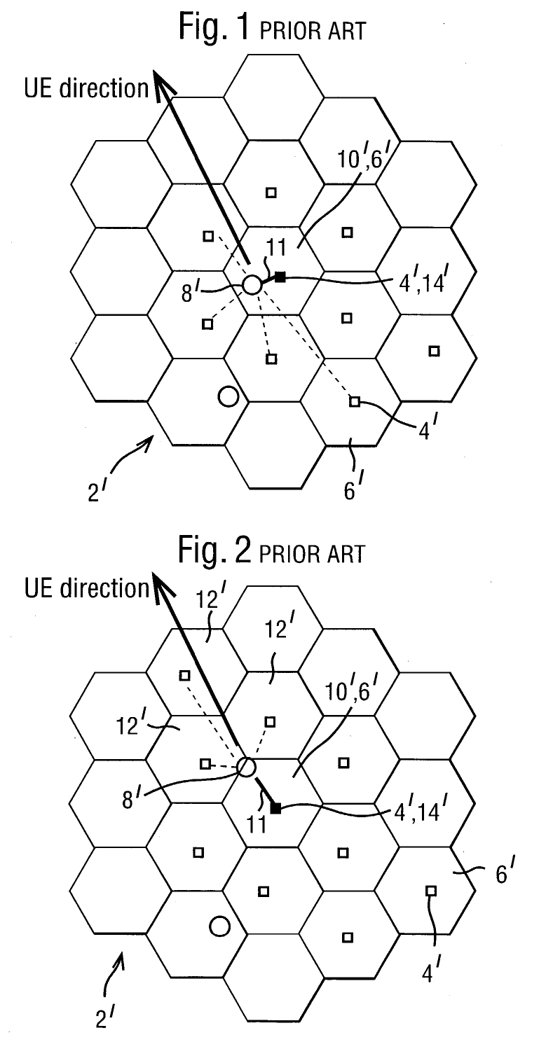

### DETAILED DESCRIPTION

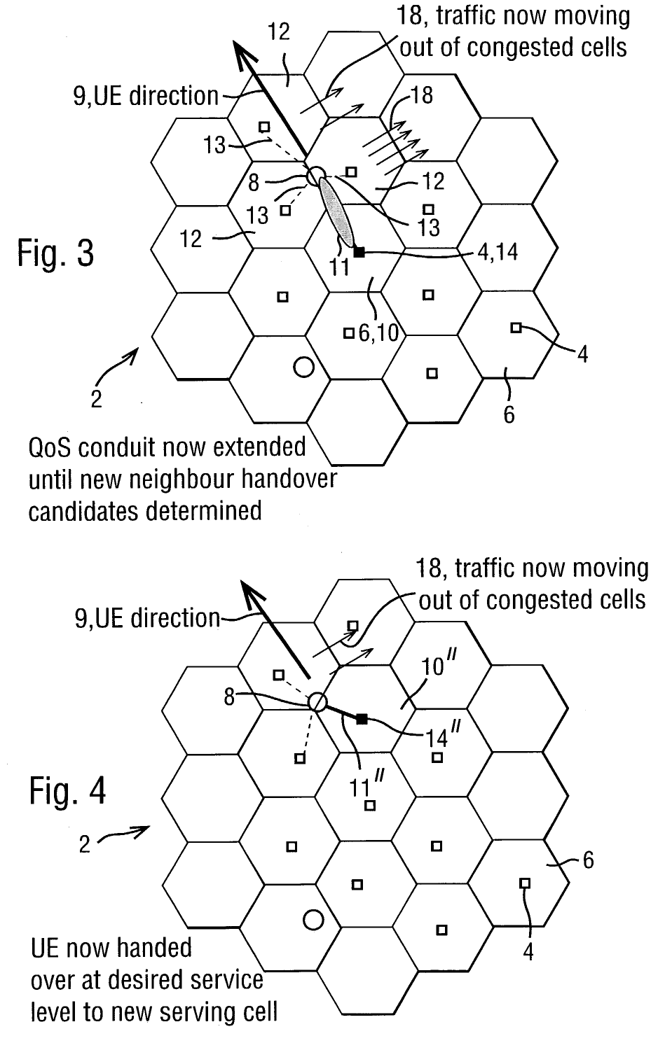

As shown in FIGS. 3 and 4, a mobile radio telecommunications network 2, such as a Univeral Mobile Telecommunications System UMTS network, consists of a network of base transceiver stations (BTS, base stations) 4 each having an associated cell (area of coverage) 6. A mobile user terminal (user equipment UE) 8 within the network is served by a serving cell 10 in the sense of being in call connection 11 with the serving base station 14 in the serving cell 10. Each base station 4 includes a Rake receiver (not shown).

Basically speaking the serving base station 14 maintains communication with the user terminal beyond that base station's normal coverage area (serving cell 10) until a handover candidate i.e. neighbouring cell 12 becomes available. In particular, when, after appropriate messaging 13 to neighbour cells 12, a mobile user terminal is blocked from handing over to a neighbour cell at a desired service level, a connection to a serving cell at the desired service level is maintained until the call can be handed over to a new cell so as to maintain the desired service level.

As shown in FIG. 3, as the mobile user terminal UE 8 moves in a direction 9 so as to cross a cell boundary, if no radio resources are available from neighbour cells 12 which are candidate cells for handover, a radio resource control (RRC) algorithm is run at a radio network controller RNC (not shown) which controls the base station 4 in the serving cell 10 (i.e. the serving base station 14) so as to maintain the call connection to the mobile user terminal UE 8.

This is done by several steps, one of which is by maintaining the call connection for data transmitted from the mobile user terminal UE 8 to the serving base station 14 in the serving cell 10 (i.e. extending radio resources on the uplink) beyond the usual (initially planned) boundary. This involves changing cell boundary information stored at the serving base station 14 (i.e. informing the serving base station 14 that it is permitted to continue to communicate with the mobile user terminal UE 8 outside the normal boundary of serving cell 10 provided the signals from the mobile user terminal 8 are sufficiently strong to permit acceptable reception.

A second step is to use two or more additional Rake fingers (not shown) to three Rake fingers (not shown) initially in use in a Rake receiver (not shown) in the serving base station 14 to improve alleviation of fade and multipath effects and so maintain acceptable reception.

A third step is to increasing power of uplink transmission by the mobile user terminal 8 so as to allow good reception by the serving base station 14 further away than normal.

A fourth step is to move traffic out of congested neighbour cells 12 to other suitable cells 16 so as to free up resources in the neighbour cells 12 sufficiently that one of the neighbour cells 12 can then accept handover of the mobile user terminal 8 to itself, in particular at the desired quality of service QoS level. This movement of traffic is indicated by arrows 18 in FIGS. 3 and 4. As shown in FIGS. 3 and 4, traffic from congested neighbour cells 12 is moved, whilst, as shown in FIG. 3, the mobile user terminal UE is held call-connected 11 to the serving cell 10 for a sufficient time to acquire a new neighbour list, amongst which neighbour cells 12 that are handover candidates become available.

As shown in FIG. 4, the mobile user terminal UE is then handed over to the new serving cell 10″ selected from the new neighbour list so as to be call connected 11″ at the desired QoS service level to the new serving base station 14″.

1. A method of handover of a call connection with a mobile user terminal from a first base station to a second base station in a cellular telecommunications network, each base station having an associated cell, the method comprising the step of:
maintaining the call connection with the first base station whilst the mobile user terminal is outside the cell associated with the first base station until handover of the call connection to the second base station.

2. The method according to claim 1, comprising the step of:
having the call connection to the first base station with an associated quality of service level, that quality of service level being maintained after handover to the second base station.

3. The method according to claim 1, comprising the step of:
informing the first base station that it is permitted to continue to communicate with the mobile user terminal outside of the usual boundary of the cell of the first base station.

4. The method according to claim 3 in which the permission is conditional on signals from the mobile user terminal being sufficiently strong as to permit acceptably accurate reception.

5. The method according to claim 1, comprising the step of:
using at the first base station a Rake receiver having multiple fingers, additional fingers being used whilst the mobile user terminal is outside the cell associated with the first base station and in call connection with the first base station so as to improve accuracy of reception.

6. The method according to claim 1, comprising the step of:
increasing transmission power of the mobile user terminal whilst the mobile user terminal is outside the cell associated with the first base station and in call connection with the first base station so as to improve accuracy of reception.

7. The method according to claim 1 comprising the step of:
maintaining the call connection with the first base station whilst the mobile user terminal is outside the cell associated with the first base station whilst neighbour cells to the cell of the first base station are congested.

8. The method according to claim 7 comprising the step of:
transferring traffic to further cells so as to free up resources in the neighbour cells sufficiently that the base station in at least one of the neighbour cells can accept the handover.

9. The method according to claim 7 comprising the step of:
identifying neighbour cells in a neighbour list stored at the first base station and updated periodically.

10. The method according to claim 1, in which the telecommunications network is a third generation or higher telecommunications network.

11. The method according to claim 1, in which the telecommunications network is a Universal Mobile Telecommunications System UMTS network.

12. A cellular telecommunications network comprising a first base station and a second base station, each base station having an associated cell, the first base station being operative to be in a call connection with a mobile user terminal in which the call connection with the first base station is maintained whilst the mobile user terminal is outside the cell associated with the first base station until handover of the call connection to the second base station.

13. The network according to claim 12, in which the call connection to the first base station has an associated quality of service level, that quality of service level being maintained after handover to the second base station.

14. The network according to claim 12, in which the first base station is informed that it is permitted to continue to communicate with the mobile user terminal outside of the usual boundary of the cell of the first base station.

15. The network according to claim 14 in which the permission is conditional on signals from the mobile user terminal being sufficiently strong as to permit acceptably accurate reception.

16. The network according to claim 12, in which the first base station comprises a Rake receiver having multiple fingers, additional fingers being used whilst the mobile user terminal is outside the cell associated with the first base station and in call connection with the first base station so as to improve accuracy of reception.

17. The network according to claim 12, in which the transmission power of the mobile user terminal is increased whilst the mobile user terminal is outside the cell associated with the first base station and in call connection with the first base station so as to improve accuracy of reception.

18. The network according to claims 12, in which the call connection is maintained with the first base station whilst the mobile user terminal is outside the cell associated with the first base station whilst neighbour cells to the cell of the first base station are congested.

19. The network according to claim 18, in which traffic is transferred to further cells so as to free up resources in the neighbour cells sufficiently that the base station in at least one of the neighbour cells can accept the handover.

20. The network according to claim 18, in which neighbour cells are identified in a neighbour list stored at the first base station and updated periodically.

21. The network according to claim 12, which is a third generation or higher telecommunications network.

22. The network according to claim 12, which is a Universal Mobile Telecommunications System UMTS network.

23. A telecommunications base station having an associated cell, the base station being operative to be in a call connection with a mobile user terminal, the call connection being maintained whilst the mobile user terminal is outside the cell until handover of the call connection to a further base station.

24. The base station according to claim 23, in which the call connection to the base station has an associated quality of service level, that quality of service level being maintained after handover.

25. The base station according to claim 23, in which the base station is informed that it is permitted to continue to communicate with the mobile user terminal outside of the usual boundary of the cell.

26. The base station according to claim 25 in which the permission is conditional on signals from the mobile user terminal being sufficiently strong as to permit acceptably accurate reception.

27. The base station according to claim 23, in which the base station comprises a Rake receiver having multiple fingers, additional fingers being used whilst the mobile user terminal is outside the cell associated with the base station and in call connection with the base station so as to improve accuracy of reception.

28. The base station according to claim 23, in which the call connection is maintained with the base station whilst the mobile user terminal is outside the cell associated with the base station whilst neighbour cells to the cell of the base station are congested.

29. The base station according to claim 23, in which neighbour cells are identified in a neighbour list stored at the base station and updated periodically.

30. The base station according to claim 23, which is a third generation or higher telecommunications base station.

31. The base station according to claim 23, which is a Universal Mobile Telecommunications System UMTS base station, under the control of a radio network controller.
